(19) United States
(12) Patent Application Publication
(10) Pub. No.: US 2006/0198544 A1
(43) Pub. Date: Sep. 7, 2006

(54) Ear hanger type earset

(75) Inventor: Wen-Hsiang Yueh, Sinjhuang City (TW)

Correspondence Address: BACON & THOMAS, PLLC, 625 SLATERS LANE, FOURTH FLOOR, ALEXANDRIA, VA, 22314, US

(73) Assignee: Partner Tech. Corporation, Taipei County (TW)

(21) Appl. No.: 11/067,683

(22) Filed: Mar. 1, 2005

(51) Int. Cl. H04R 25/00

(52) U.S. Cl. 381/381; 381/370

(57) ABSTRACT

An ear hanger type earset of the present invention comprises an earset housing having a speaker; a pivotal portion having an elastomer to be pivotally connected to the earset housing; and an ear hanger portion to be joined to the pivotal portion, configured in the shape of an arc body, and then integrated on the periphery of the arc body to dispose a projecting element. By enhancing the rotational elasticity between the earset housing and the pivotal portion, the projecting element of the ear hanger portion is used as a fulcrum for rotation, so as to facilitate the rotation of the ear hanger portion. The ear hanger portion can securely be hooked onto the back of the ear while the user is exercising with the earset on.

### FIELD OF THE INVENTION

The present invention relates to an ear hanger type earset, and more particularly, to an improved ear hanger type earset that is capable of enhancing the rotational elasticity of the ear hanger.

### BACKGROUND OF THE INVENTION

With the progress of 3C telecommunications (computer, communication, and consumer electronics) and the convenience of electronic telecommunications products, earsets have already become commonly used nowadays. For example, for listening to music, using mobile phones, or using the Internet for communication, the earset and the microphone are frequently used as a medium of communication. Nowadays, there are numerous types and shapes of earsets available in the market. Based on the usage, earsets can be classified into the following types: the earplug type, the headset type, the ear hanger type, and so on.

Please refer to FIG. 1, which depicts a structural diagram of the design of a conventional ear hanger type earset. The conventional ear hanger type earset 200 comprises an earset housing 4 and a hanger 5 that is connected to the earset housing 4. The earset housing 4 is then joined to the hanger 5 by a pivotal portion 6, and moreover, the hanger 5 is provided with supporting and fixing capability by means of the user's ear, so that the speaker disposed inside the earset housing 4 falls close to a location on the user's ear, and when the user wants to hang the earset 200, the user holds the hanger 5 with the finger and then rotates the hanger 5 toward the open direction, so that the hanger 5 is open at an angle and can thus be hung onto the user's ear.

However, conventional ear hangers are configured in the form of smooth surfaces, and when the user rotates the hanger with his finger to hang the earset, the friction between the user's finger and the hanger is thus reduced because the hanger is configured in the form of a smooth surface, so that it is easy to get the hanger detached while opening the hanger. Hence, if the friction between the earset housing and the hanger is increased, the hanger will be more securely attached to the user's ear while the user exercises with the earset on; however, due to the increase in elasticity, the force that is required to open the hanger is also increased correspondingly, so that it is not sufficient to apply only the user's finger to hold and rotate the hanger.

### SUMMARY OF THE INVENTION

As the ear hanger of the conventional ear hanger type earset is configured in the form of a smooth surface, the friction between the user's finger and the hanger is thus reduced, so that it is easy to get the hanger detached while opening the hanger. Moreover, if the elasticity between the earset housing and the hanger is increased, the force that is required to open the hanger is increased correspondingly, so that it is conventionally known that it is not easy to hold and rotate the hanger just with the user's finger.

To overcome the abovementioned shortcomings, it is the primary object of the present invention to provide an ear hanger type earset that is capable of enhancing the elasticity between the earset housing and the hanger, such that the earset can become more securely hooked onto the back of the ear while the user is carrying the earset.

It is another object of the present invention to provide an ear hanger type earset having a projecting element disposed on an arc body of the ear hanger, such that the elasticity of the ear hanger is enhanced, so as to facilitate the rotation of the ear hanger and then hanging it onto the back of the user's ear.

To achieve the aforementioned objects of the present invention, the ear hanger type earset disclosed in the embodiment of the present invention comprises: an earset housing having a speaker; a pivotal portion having an elastomer and pivotally connected to said earset housing; an ear hanger portion to be joined to said pivotal portion, configured in the shape of an arc body, and then integrated on the arc body to dispose a projecting element. By enhancing the rotational elasticity between said earset housing and said pivotal portion, said projecting element of said ear hanger portion is used as a fulcrum to facilitate the rotation of said ear hanger portion.

One preferred embodiment of the present invention discloses the ear hanger type earset wherein said projecting element can further become integrated and is then externally hung onto said arc body.

Another preferred embodiment of the present invention discloses the ear hanger type earset wherein said projecting element is configured in the shape of a curved body.

Another preferred embodiment of the present invention discloses the ear hanger type earset wherein said elastomer of said pivotal portion is disposed to provide the rotational elasticity between said earset housing and said ear hanger portion.

Hence, the ear hanger type earset made according to the embodiments of the present invention can effectively enhance the rotational elasticity between said earset housing and said pivotal portion, such that said ear hanger portion can securely be hooked onto the back of the ear while the user is exercising with the earset on, and said ear hanger portion is not easy to get loosened and detached, so as to enhance its fixing capability; along with an increase in rotational elasticity, the force that is required to rotate said ear hanger portion is also increased correspondingly. Moreover, said projecting element of said ear hanger portion is used as a fulcrum for rotation to facilitate the rotation of said ear hanger portion.

### BRIEF DESCIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a structural diagram of the design of a conventional ear hanger type earset.

FIG. 2 shows a structural diagram of the design of the ear hanger type earset disclosed in the present invention.

FIG. 3 shows an illustration of the movement of the ear hanger type earset disclosed in the present invention.

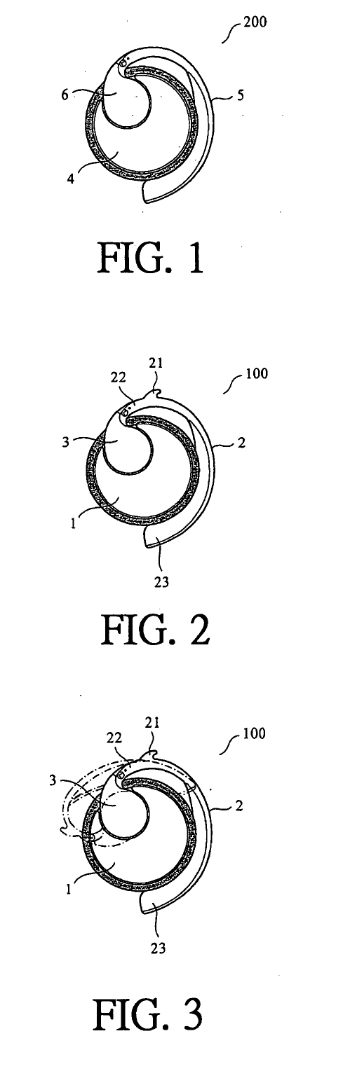

### DETAILED DESCRIPTION OF THE PREFERRED EMBODIMENTS

According to FIG. 2, which shows a structural diagram of the design of the ear hanger type earset disclosed in the present invention, the ear hanger type earset 100 disclosed in the embodiment of the present invention comprises: an earset housing 1 having a speaker; a pivotal portion 3 having an elastomer and pivotally connected to said earset housing 1; an ear hanger portion 2 to be joined to said pivotal portion 3, configured in the shape of a curved arc body, and then integrated on said arc body to dispose a projecting element 21.

Additionally, according to FIG. 2, said ear hanger portion 2 comprises a fixed end 22 and a free end 23; said fixed end 22 is connected to said pivotal portion 3, such that said ear hanger portion 2 is joined to said earset housing 1, and said projecting element 21 of said ear hanger portion 2 is disposed on one side of said fixed end 22 to facilitate the rotation of said ear hanger portion 2; moreover, said projecting element 21 is configured in the shape of a curved body so that the user can use the finger tip to hold and rotate said ear hanger portion 2; said elastomer of said pivotal portion 3 is disposed to provide rotational elasticity between said earset housing 1 and said ear hanger portion 2. By enhancing the rotational elasticity between said earset housing 1 and said ear hanger portion 2, said ear hanger portion 2 can securely be hooked onto the back of the user's ear while the user is exercising with the earset 100 on, so that said ear hanger portion 2 is not easy to get loosened and detached, so as to enhance its fixing capability; along with an increase in the rotational elasticity between said earset housing 1 and said pivotal portion 3, the force that is required to rotate said ear hanger portion 2 is also increased correspondingly. Hence, said projecting element 21 of said ear hanger portion 2 is used as a fulcrum for rotation to facilitate the rotation of said ear hanger portion 2.

When the user rotates said ear hanger portion 2 to hang said earset 100, the user first uses the tip of the index finger to hold said projecting element 21 of said fixed end 22 of said ear hanger portion 2 and then rotate said ear hanger portion 2, and then said free end 23 of said ear hanger portion 2 rotates in the shape of an arc; said ear hanger portion 2 is then disposed on the back of the user's ear, and through the rebounding force achieved by elasticity, said ear hanger portion 2 is made securely attached onto the back of the user's ear, so as to complete the hanging of the earset.

Along with FIG. 2, please refer to FIG. 3, which shows an illustration of the movement of the ear hanger type earset disclosed in the present invention, in which when the user wants to hang said earset 100, he first uses the tip of the index finger to hold and rotate said projecting element 21 of said fixed end 22 of said ear hanger portion 2, such that said pivotal portion 3 is also rotated to an angle so as to make said fixed end 22 of said ear hanger portion 2 move downward. In the meantime, the free end 23 of said ear hanger portion 2 is linked to move backward in an arc, such that the distance between said earset housing 1 and said ear hanger portion 2 becomes larger; afterwards, said ear hanger portion 2 is hung onto the back of the user's ear, and through the rebounding force achieved by elasticity, said ear hanger portion 2 is made securely attached onto the back of the user's ear, such that said earset 100 is not easily loosened; moreover when removing said earset 100, said projecting element 21 of said ear hanger portion 2 is also used to facilitate its rotation, so that it is easy for the user to take off said earset 100.

While the invention has been described by way of examples and in terms of preferred embodiments, it is to be understood that the invention is not limited thereto. To the contrary, it is intended to carry out various modifications and similar arrangements and procedures, and the scope of the appended claims therefore should be accorded the broadest interpretation so as to encompass all such modifications and similar arrangements and procedures. For example, the projecting element of the ear hanger portion of the ear hanger type earset disclosed in the present invention is not limited to the integration only with an arc body, but also can be integrated on its own and then externally hung on the arc body of the ear hanger portion.

What is claimed as:

1. An ear hanger type earset comprising:
an earset housing;
a pivotal portion having an elastomer and pivotally connected to said earset housing; and
an ear hanger portion to be joined to said pivotal portion, configured in the shape of an arc body, and then integrated on the periphery of said arc body to dispose a projecting element;
by enhancing the rotational elasticity between said earset housing and said pivotal portion, said projecting element of said ear hanger portion is used as a fulcrum to facilitate the rotation of said ear hanger portion.

2. The ear hanger type earset as claimed in claim 1, wherein said projecting element can further become integrated and is then externally hung onto said arc body.

3. The ear hanger type earset as claimed in claim 1 or claim 2, wherein said projecting element is configured in the shape of a curved body.

4. The ear hanger type earset as claimed in claim 1, wherein said elastomer of said pivotal portion is disposed to provide the rotational elasticity between said earset housing and said ear hanger portion.
